(19) United States
(12) Patent Application Publication
(10) Pub. No.: US 2008/0204261 A1
(43) Pub. Date: Aug. 28, 2008

(54) Balanced salt solution alarm

(76) Inventor: Michael N. Wiggins, Maumelle, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 12/070,681

(22) Filed: Feb. 20, 2008

Related U.S. Application Data
(60) Provisional application No. 60/904,082, filed on Feb. 28, 2007.

(51) Int. Cl. G08B 21/00

(52) U.S. Cl. 340/613

(57) ABSTRACT

An inexpensive, audible alarm to alert the surgeon when the level of Basic Salt Solution (BSS) falls dangerously low during a cataract surgical procedure. A digital weight gauge is suspended from the BSS pole of the phacoemulsification unit. The BSS bottle is suspended from the weight gauge. As the BSS leaves the bottle, the weight of the bottle decreases. When the digital weight gauge reaches a predefined minimum weight, an audible alarm is activated. The alarm may be provided with an on/off switch so that the alarm may be deactivated when it is not in use. The weight gauge may also have a programmable setting to adjust to the surgeon's preference for timing of notification.

### CROSS-REFERENCE TO RELATED APPLICATIONS

This application claims the benefit of U.S. Provisional Application No. 60/904,082 filed Feb. 28, 2007, the disclosure of which is incorporated herein in its entirety by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to phacoemulsification cataract surgery, and in particular, to an alarm system for alerting a surgeon when the level of balanced salt solution (BSS) becomes dangerously low during such surgery.

2. Brief Description of the Related Art

Various surgical techniques are known for treating a patent whose eyes have lenses clouded by cataracts. Phacoemulsification is one such surgical technique for removing lens having cataracts. A typical handpiece used in phacoemulsification surgery comprises an ultrasonically driven cutting tip, an irrigating sleeve and a control console. Irrigation fluid is supplied to the handpiece and aspiration fluid is withdrawn from the eye. Balanced salt solution (BSS) is used to keep the eye inflated during the procedure.

If the BSS bottle runs empty during a procedure, many serious and unnecessary complications can occur. These complications can adversely affect the vision of the patient postoperatively. Since cataract surgery is done under a microscope, the surgeon is unable to monitor the BSS level during the surgical procedure while looking through the microscope. This task falls to the circulating scrub nurse, who has many other tasks to perform simultaneously, to frequently check the BSS level during the procedure.

### BRIEF SUMMARY OF THE INVENTION

The present invention is directed to an apparatus that satisfies this need. The apparatus is an inexpensive, audible alarm to alert the surgeon when the level of BSS falls dangerously low during a cataract surgical procedure.

The apparatus comprises a digital weight gauge suspended from the BSS pole of the phacoemulsification unit. The weight of the BSS bottle is directly proportional to the amount of BSS remaining in the bottle. Therefore, as the BSS leaves the bottle, the weight of the bottle decreases. When the digital weight gauge reaches a predefined minimum weight, an audible alert is activated. The alert warns the surgeon to stop operating until a new bottle of BSS can be placed into operation. A visual alert may also be included in the apparatus.

The alarm may be provided with an on/off switch so that the alarm may be deactivated when it is not in use. The digital weight gauge may also have a programmable setting to adjust to the surgeon's preference for timing of notification.

These and other features, objects and advantages of the present invention will become better understood from a consideration of the following detailed description of the preferred embodiments and appended claim in conjunction with the drawings as described following:

### BRIEF DESCRIPTION OF THE SEVERAL VIEWS OF THE DRAWINGS

FIG. 1 is a front elevation view of the BSS alarm of the present invention suspended from a BSS pole of a phacoemulsification unit with the BSS bottle suspended from the alarm.

FIG. 2 is a block diagram of the functional components of an embodiment of the BSS alarm.

FIG. 3 is front elevation view of an embodiment of the BSS alarm illustrating the front panel.

### DETAILED DESCRIPTION OF THE INVENTION

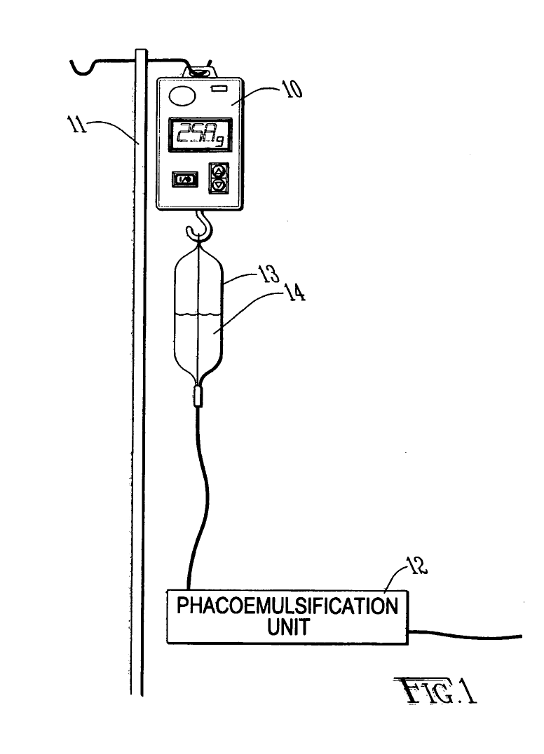

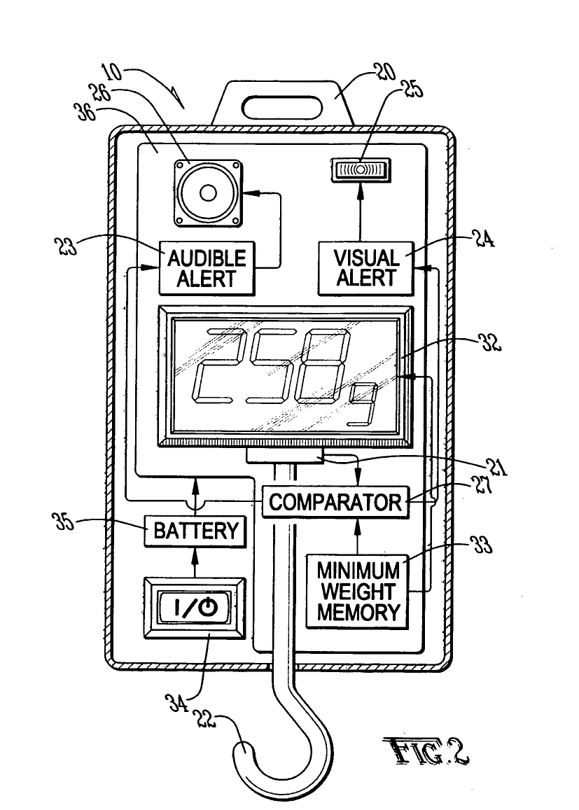

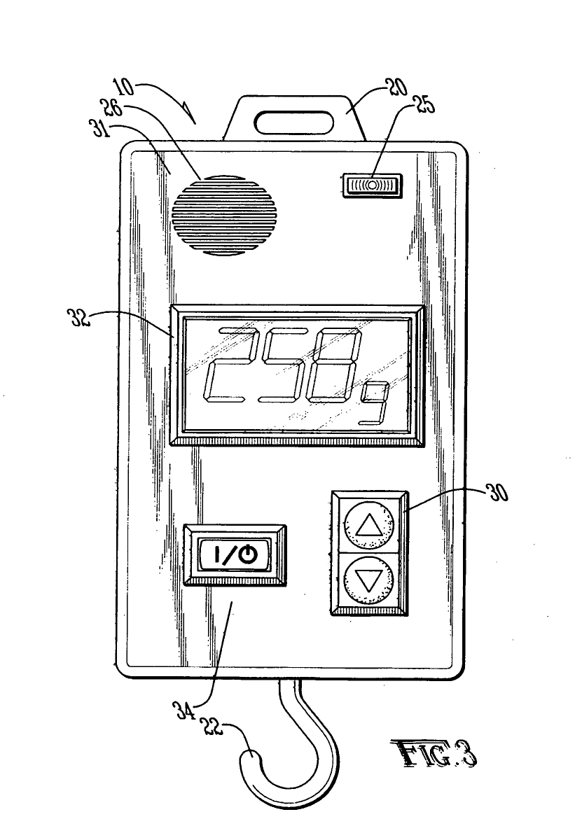

With reference to FIGS. 1-3, the preferred embodiments of the present invention may be described as follows.

The apparatus of the present invention comprises a weight alarm 10 suspended by a loop 20 from the BSS pole 11 of the phacoemulsification unit 12. The weight alarm 10 comprises a digital weigh gauge 21 having a hook 22 from which the BSS bottle 13 is suspended from the digital weight gauge 10 in such a manner that the weight of the BSS bottle 13 including the BSS 14 is continuously weighed by the digital weight gauge 21. Although in the preferred embodiment of the invention, the weight gauge is digital in operation, an analog weight gauge is also considered to be within the scope of the present invention.

The weight of the BSS bottle 13 is directly proportional to the amount of BSS 14 remaining in the bottle 13. Therefore, as the BSS 14 leaves the bottle 13, the weight of the bottle 13 decreases. The surgeon may set a minimum weight at which he/she desires to be warned. The predetermined minimum weight may be set by a pair of up/down switches 30 on a front panel 31 as described more fully below. The predetermined minimum weight may be stored in a minimum weight memory 33 and displayed in a display 32. The minimum weight memory 33 may be implement in suitable electronic circuitry known to those skilled in the art. The display 32 is desirably a large digital display that would be easy to read in an operating room environment.

When the digital weight gauge 10 reaches a predefined minimum weight as determined by a comparator 27, an audible alert 23 is activated. The comparator 27 may be implemented in suitable electronic circuitry that would be known to those of skill in the art. The audible alert 23 warns the surgeon to stop operating until a new bottle 13 of BSS can be placed into operation. The audible alert 23 may comprise a speaker 26 operatively connected to suitable electronic circuitry that would be known of those of skill in the art. The audible alert 23 should be of sufficient volume to be heard over typical operating room noise, but not so loud as to startle the surgeon. For this reason, it is desirable that the audible alert 23 should be equipped with a volume control. Although the surgeon will probably not be in a position to observe a visual signal, for the convenience of the operating staff, a visual alert 24 may also be included in the BSS weight alarm 10. The visual alert 24 may comprise a flashing light 25, such as a light emitting diode (LED).

As mentioned, the various functions described above may be implemented in electronic circuitry known to those skilled in the art. For example, the circuitry may be placed on a circuit board 36 powered by a battery 35. The alarm 10 may be provided with an on/off switch 34 operatively connected to the battery 35 for removing power from the circuitry. The on/off switch 34 allows the alarm 10 to be deactivated when it is not in use. The on/off switch 34 should be located on the alarm 10 for ease of access, since the surgeon may want the unit deactivated during surgery. Although not so limited, a preferred location for the on/off switch is on the side of the alarm 10.

As mentioned, the alarm 10 is desirably programmable to adjust to the surgeon's preference for timing of notification; i.e., the surgeon may determined the weight of BSS at which the alarm will sound. For example, a simple array of arrow up/arrow down switches 30 may be used to set the weight at which the alarm sounds. It is desirable that the switches 30 be easy to locate and use in a darkened operating room. For example, a surgeon may initially have the alarm 10 set to activate at a weight equivalent to 50 cc of BSS 14 remaining in the BSS bottle 13. Then at 50 cc the alarm 10 activates, but the surgeon is nearing completion of the operation and either wants to turn the alarm 10 off or reset it to activate at 25 cc. Either task should be easy to perform.

The alarm 10 should be programmable over a range of weights appropriate for the particular operation. For example, an Alcon 500 ml BSS bottle weighs approximately ¼ lb (113 g) when 50 cc of BSS (10% of the full amount) remain in the bottle, while a bottle containing 100 cc may weigh between ¼ lb (113 g) and ½ lb (227 g) (20% of the full amount). The programming weight range is desirably from a weight that represents approximately 20% of the original amount of BSS to a weight that represents approximately 5% of the original amount. In the example of an Alcon 500 ml bottle of BSS, the desirable range be approximately 227 g to 57 g. For other applications, the weight range representing 20% to 5% would differ depending on the weight of the bottle and the weight of the irrigating solution contained therein.

Although described with reference to the phacoemulsification procedure, the present invention may find application in any intraocular procedure that requires irrigation into the eye. Further, non-ophthamological procedures that require irrigation into a body cavity when irrigation is critical may benefit from the present invention. In such cases the bottle may contain some fluid other than BSS.

In the preferred embodiment, the present invention is capable of being added onto an existing phacoemulsification unit. In an alternative embodiment, the digital weight gauge and alarm may be built into the phacoemulsification unit. In this alternative embodiment, it might be desirable to replace the weight gauge with a sensor to measure the flow rate through the tubing, similar to sensors employed with intravenous infusion devices.

The present invention has been described with reference to certain preferred and alternative embodiments that are intended to be exemplary only and not limiting to the full scope of the present invention.

What is claimed is:

1. An alarm system for alerting a surgeon when the level of an irrigating fluid dispensed from a container for irrigation into a body cavity becomes critically low during a surgical procedure requiring irrigation into the body cavity, comprising:
an audible alarm;
means for setting a predefined minimum weight of the irrigating fluid and the container; and
means for activating said audible alarm when said predefined minimum weight occurs.

2. The alarm system of claim 1, wherein said means for activating said audible alarm comprises a weight gauge operatively disposed for determining a weight of the irrigating fluid and the container, for comparing said weight to said predefined minimum weight, and for activating said audible alarm when said weight equals said predefined minimum weight.

3. The alarm system of claim 2, wherein said weight gauge is digital.

4. The alarm system of claim 2, wherein said weight gauge is analog.

5. The alarm system of claim 1, wherein said means for setting a predefined minimum weight comprises an array of “arrow up/arrow down” switches.

6. The alarm system of claim 1 wherein said predefined minimum weight may be set in a weight range equivalent to a range of remaining irrigating solution of from approximately 20% of an original amount to approximately 5% of said original amount.

7. The alarm system of claim 1, wherein the surgical procedure is an intraocular procedure.

8. The alarm system of claim 7, wherein the irrigating fluid is a balanced salt solution (BSS) and said surgical procedure is a phacoemulsification procedure.

9. The alarm system of claim 1, wherein the irrigating fluid is a balanced salt solution (BSS) and the surgical procedure is a phacoemulsification procedure using a phacoemulsification unit having a BSS pole and a BSS bottle containing said balanced salt solution, wherein said audible alarm comprises a weight gauge, and further comprising:
means for supporting said weight gauge from the BSS pole;
means for operatively supporting the BSS bottle from said weight gauge, for determining a weight of the BSS bottle and the balanced salt solution contained therein, comparing said weight to said predefined minimum weight, and activating said audible alarm when said weight equals said predefined minimum weight.

10. The alarm system of claim 9, wherein said weight gauge is digital.

11. The alarm system of claim 9, wherein said weight gauge is analog.

12. The alarm system of claim 9, wherein said means for setting said predefined minimum weight comprises an array of “arrow up/arrow down” switches.

13. The alarm system of claim 9 wherein said predefined minimum weight may be set in a weight range equivalent to a range of remaining balanced salt solution of from approximately 20% of an original amount to approximately 5% of said original amount.
